(19) United States
(12) Patent Application Publication
(10) Pub. No.: US 2008/0313077 A1
(43) Pub. Date: Dec. 18, 2008

(54) System and method for coordinating charitable contributions

(76) Inventor: David W. Schropfer, Shrewsbury, NJ (US)

Correspondence Address: BLANK ROME LLP, 600 NEW HAMPSHIRE AVENUE, N.W., WASHINGTON, DC, 20037, US

(21) Appl. No.: 12/213,133

(22) Filed: Jun. 16, 2008

Related U.S. Application Data
(60) Provisional application No. 60/929,146, filed on Jun. 15, 2007.

(51) Int. Cl. G06Q 40/00

(52) U.S. Cl. 705/39

(57) ABSTRACT

A system and method allows charitable organizations through banking partners to calculate, collect and distribute monetary donations provided by financial institutions based on those institution's credit or debit cardholders who have opted to make monetary donations to beneficiaries based on their card usage. The process of making monetary donations by individuals who wish to make such donations is thereby automated and simplified, thus encouraging frequent donations. A donation amount is a simple to understand fixed amount times the aggregate number of transactions made using the card.

### CROSS-REFERENCE TO RELATED APPLICATIONS

The present application claims the benefit of an earlier filed U.S. Provisional Patent Application No. 60/929,146, filed Jun. 15, 2007, the contents of which are incorporated in their entirety herein.

### BACKGROUND OF THE INVENTION

1. Field of Invention

The present invention relates to coordinating charitable contributions, such as monetary donations, between donors and beneficiaries. In particular, the present invention relates to computer-implemented systems and methods for collecting and distributing donations from consumers that are determined based on consumer-initiated commercial transactions involving the purchase of goods and/or services using a revolving debt financial instrument, or electronic debit system based on a consumer or business bank account.

2. Description of the Related Art

Although not everyone can afford to donate large sums of money or provide other charity to needy individuals or organizations, many people would feel comfortable offering at least a few pennies over the course of a period of time to those individuals and organizations. Small donations from many persons can, when aggregated, make a significant difference in the lives of others. In response, it is not surprising that systems and methods for collecting monetary donations have been developed to assist or encourage people to make small, regular donations.

One such system and method involves indexing donations to the use of revolving debt financial instruments, such as store-issued or bank-issued credit cards, or the use of debit or prepaid cards. Because those kinds of cards were involved in over 40 billion transactions in the U.S. in 2007, and are expected to approach 60 billion by 2013, the potential exists for generating significant donations from the use of credit and debit cards. Such systems and methods involve, for example, collecting money donations during point of sale transactions, during Internet commerce sessions, or by aggregating credit card usage or transaction amounts post-transaction.

U.S. Patent Appl. Publication No. 20030028483, for example, discloses a system and method for funding a credit card user's “collective account,” such as a charitable account, by issuing a plurality of financial instruments (such as credit cards), linking the financial instruments to the collective account, aggregating individual financial instrument usage, calculating a bonus or other reward based on the aggregate financial instrument usage, and funding or distributing the reward to the collective account. According to the invention, members of a civic, charitable, political or other entity may generate collective rewards or other benefits which may be attributed to the designated organization.

U.S. Patent Appl. Publication No. 20020111904, on the other hand, discloses a method and system for soliciting charitable donations from on-line shoppers during electronic commerce, i.e., at the time of purchasing a consumer good or service.

U.S. Pat. No. 6,112,191 discloses a donation system involving the use of credit cards for making donations at the time of purchasing a good and/or service. The system is described as providing consumer payors the ability to save and donate whenever they use cash at a point of sale terminal, write a check, use an automated teller machine, or use a credit or debit card. The patent teaches using a point-of-sale system in a network composed of subscriber/payors, neutral merchant/collectors, a central clearinghouse, and provider accounts. The patent further teaches that the system is a network composed of subscriber/payors, payees, account managers, and provider services, that together provide subscriber/payors with a seamless way to save/donate every time they spend.

Other references disclose the use of “round-up” techniques, whereby an additional amount is added to the face amount of a commercial transaction for the purchase of a good and/or service, so that the total amount debited from the cardholders account is a whole number. The rounded-up additional amount is then attributed to a separate account owned by the cardholder, and designated for other purposes (e.g., personal savings, investments, tuition, charity, etc.). For.example, U.S. Patent Application Publication No. 20070033134 discloses a computer implemented method of processing a financial transaction executed by a first person that includes determining an automatic savings amount from the financial transaction by rounding up the amount of the financial transaction to the nearest dollar. The disclosed method further includes debiting the calculated savings amount from an account of the first person and crediting the savings amount to an account of a second person, which could be a charity. Before rounding up, however, the method checks the status of the account of the first person to make sure adequate funds are available.

Notwithstanding those and other similar systems and methods, none of the prior art systems and methods involve coordinating the collection of charitable contributions from credit cardholders in the manner disclosed herein. Accordingly, there exists a need for such a system and method.

In particular, there exists a need for a system and method for establishing on the financial institution's servers one or more revolving debt or debit cardholder accounts designated for outputting the charitable contributions to the charitable organization at a pre-determined time period, linking one or more data collection fields to the cardholder accounts, and providing, on the financial institution's servers, software methods adapted to computing the charitable contributions based on a pre-determined formula and also outputting a pre-formatted credit card statement to the users of the cardholder accounts showing the charitable contributions as a consumer-initiated transaction.

### SUMMARY AND OBJECTS OF THE INVENTION

Accordingly, it is a principal object of the present invention to provide a system for coordinating multiple financial institutions to calculate, collect and distribute monetary donations provided by financial institutions based on those institution's credit or debit cardholders who have opted to make monetary donations to a charitable organization.

It is another object of the present invention to provide a system for coordinating at a charitable organization the collection and distribution of monetary donations provided by financial institutions based on those institution's credit or debit cardholders who have opted to make monetary donations to a charitable organization.

It is still another object of the present invention to simplify the process of making monetary donations by individuals who wish to make such donations, by automating the process using revolving debt or debit instruments.

It is another object of the present invention to provide financial institutions with the means for easily computing a donation amount without requiring significant computing resources or an increase in the costs of administering credit card accounts.

It is still another object of the present invention to.use electronic funds transfer (EFT) methods as a safe, secure, efficient, and less expensive method for making monetary donations compared with paper check payments and collections.

It is another object of the present invention to provide a method whereby banks compute a donation amount for each cardholder that has opted in to make monetary donations linked to their card usage, debit those cardholder accounts the computed amount, and processes the donation amount as a fee-based transaction (or, in an alternative embodiment, processes an EFT as a normal credit card transaction to a charitable organization, which is exactly the same as if the cardholder made a small donation to the charitable organization directly using their credit card).

Briefly described, those and other objects and advantages of the present invention are accomplished, as embodied and fully described herein, by a computer-implemented method for coordinating monetary donations to one or more designated beneficiaries, which involves providing on a server associated with a charitable organization an account designated for receiving a donation amount by way of an electronic fund transfer from a financial institution server, and, at the financial institution server, a) providing a cardholder account for debiting the donation amount; b) linking one or more cards to the cardholder account; c) computing the donation amount based on a pre-determined formula involving multiplying a first variable representing an aggregate number of eligible transactions made using the card during a fixed period of time and a second variable representing a fixed multiplier; d) comparing the computed donation amount against a first set of criteria to determine whether to debit the cardholder account an amount equal to the computed donation amount; and e)outputting a statement associated with the cardholder account showing the donation amount. The method also involves the step of allocating the donation amount to the one or more designated beneficiaries at a pre-determined second time period or concurrently with the first time period.

The aforementioned objects and advantages of the present invention are also accomplished, as embodied and fully described herein, by a system for coordinating monetary donations to one or more designated beneficiaries involving an electronic fund receiving device associated with a charitable organization operable to receiving and storing a first data signal representing monetary donations; an electronic fund transferring means in data communication with the electronic fund receiving device for receiving and storing a second data signal representing consumer transactions associated with a card; a storage medium containing computer code instructions for aggregating card usage over a pre-determined time period and for outputting the first data signal; a means for outputting a transaction record upon receipt at the first server of the first data signal; and a means for distributing the monetary donations.

### BRIEF DESCRIPTION OF THE DRAWINGS

FIG. 1 is a schematic drawing showing a charitable donor and several charitable organizations that are to receive donations from the donor according to the present invention;

FIG. 2 is a schematic drawing showing the prior art process involved in purchasing goods and/or services from a merchant using a credit card transaction;

FIG. 3 is a process flow diagram according to one embodiment of the present invention;

FIG. 4a is another process flow diagram according to another embodiment of the present invention;

FIG. 4b is still another process flow diagram according to another embodiment of the present invention;

FIG. 5 is a schematic drawing showing various components of the system according to the present invention; and

FIG. 6 is a schematic drawing showing the interrelationship between coordination entities according to the present invention.

### DETAILED DESCRIPTION OF THE PREFERRED EMBODIMENT

Several preferred embodiments of the invention are described for illustrative purposes, it being understood that the invention may be embodied in other forms not specifically shown in the drawing. The figures will be described with respect to the system architecture and methods for using the system to achieve one or more of the objects of the invention and/or receive the benefits derived from the advantages of the invention as set forth above.

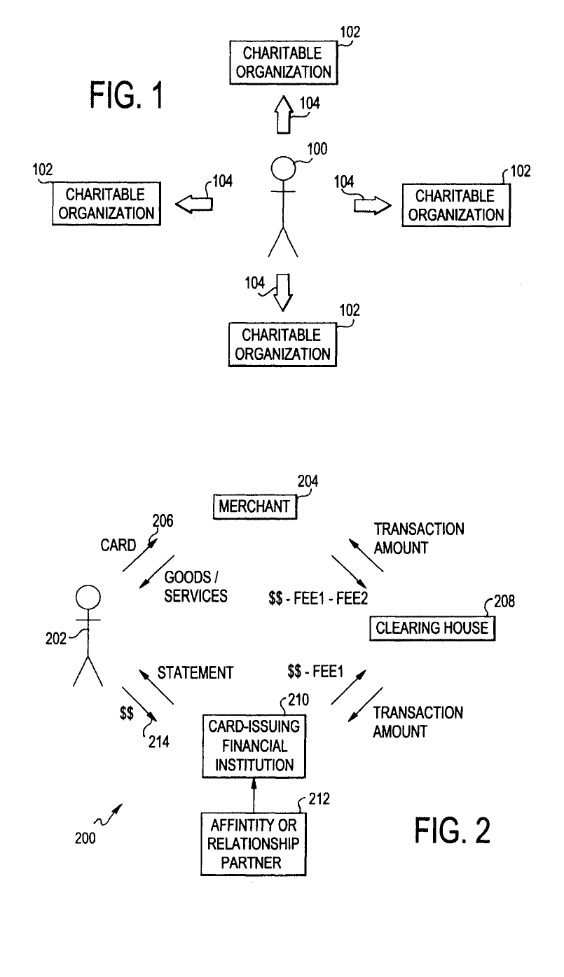

Turning first to FIG. 1, shown therein is a schematic drawing of a charitable donor 100 and several charitable organizations 102 that are to receive donations 104 from the charitable donor 100 according to the present invention. The charitable donor 100 may be an individual who wishes to contribute money to one or more of the charitable organizations 102 on a regular basis. The donations 104 are preferably monetary donation amounts, g, which may be made in any currency denomination (e.g., US dollars).

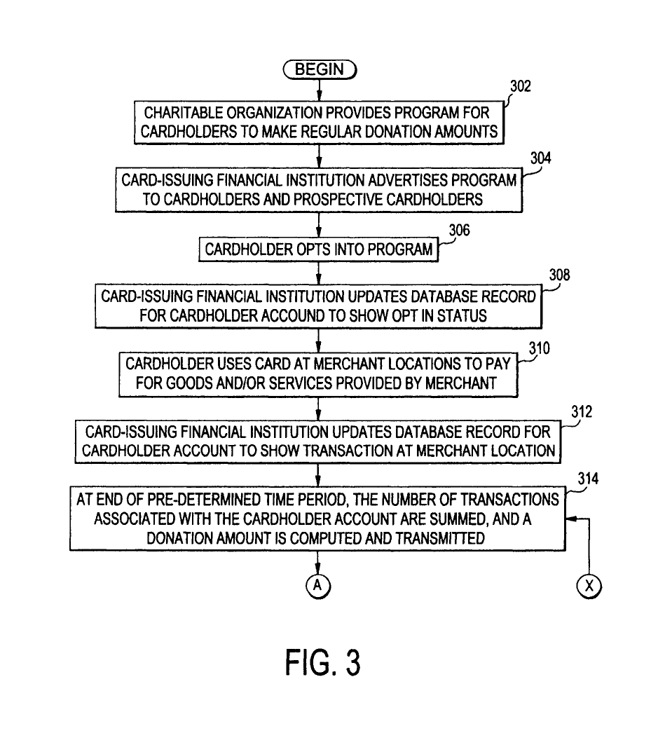

Turning now to FIG. 2, shown therein is a schematic drawing of a basic credit card transaction process 200 involving the purchase of goods and/or services by a cardholder 202 from a merchant 204. The cardholder 202, who may be a charitable donor 100, is a person or entity that owns a revolving debt charge, credit, or debit card used to complete a commercial transaction involving the purchase of one or more goods and/or services. A merchant 204 is, for example, a third party business entity that accepts card payments for goods and/or services purchased by the cardholder 202.

The process begins when the cardholder 202 makes a purchase for goods and/or services using his or her card 206, which may be a credit card, debit card, check card, pre-paid card, gift card, or other type of financial instrument that does not involve using cash to complete the transaction. To complete the transaction, the card 206 is presented by the cardholder 202 to the merchant 204.

The merchant 204 uses a clearing house 208 to process the cardholder's 202 card 204 by transferring to the clearing house 208 the amount of the transaction. The clearing house 208 is a type of card association, which is a network of entities that act as a gateway between an acquirer (not shown) and a card-issuing financial institution 210 that authorizes and funds card transactions. An acquirer is, for example, a financial institution or other organization that provides certain services to the merchant 204 involving the use of the card 206.

The clearing house 206 then contacts the card-issuing financial institution 210 to settle the amount owed by the cardholder 202. The card-issuing financial institution 210 is, for example, a financial institution that issues cards 206 to cardholders 202.

The card-issuing financial institution 210 processes a transfer of the transaction amount to the merchant 204 through the clearing house 208 (along with a small fee, which the clearing house 208 keeps).

An affinity or relationship partner 212 is, for example, an institution that lends its name to a card-issuing financial institution 210 to attract customers (i.e., new cardholders 202) that have a strong relationship with that card-issuing financial institution 210, and that receives payment, fees, or a percentage of the balance for each card 206 issued using its name. In this case, the affinity or relationship partner may be a charitable organization 102.

At the end of a pre-determined time period, the card-issuing financial institution 210 sends a statement 214 to the cardholder 202 and receives money from the cardholder 202 on or before the due date printed on the statement 214.

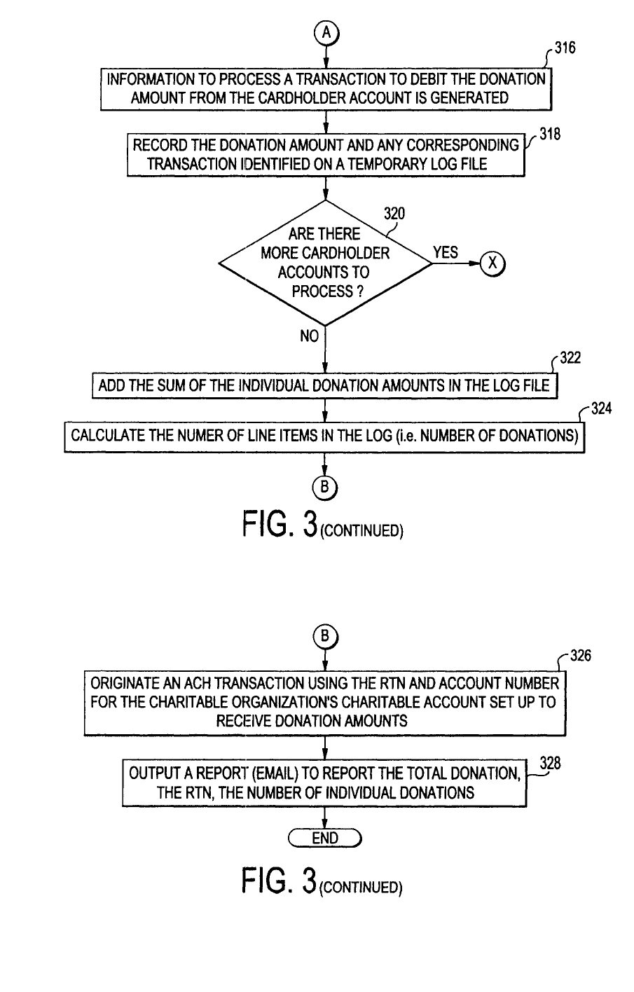

Turning now to FIG. 3, shown therein is a process flow diagram for one embodiment of the present invention. In step 302, a charitable organization 102 provides or establishes a program for cardholders 202 to make regular donation amounts, g, to the charitable organization 102.

In step 304, the card-issuing financial institution 210 advertises the program to cardholders 202 and prospective cardholders. The cardholder 202 interested in making regular monetary donation amounts to the charitable organization 102 may select a card-issuing financial institution 210 to facilitate making those donations.

In step 306, the cardholder 202 may optionally enroll in such a program offered by a participating card-issuing financial institution 210 in order to donate a fixed or variable donation amount to the charitable organization at the end of the cardholder's 202 billing cycle (e.g., a monthly credit card cycle), or at or after some other designated time period.

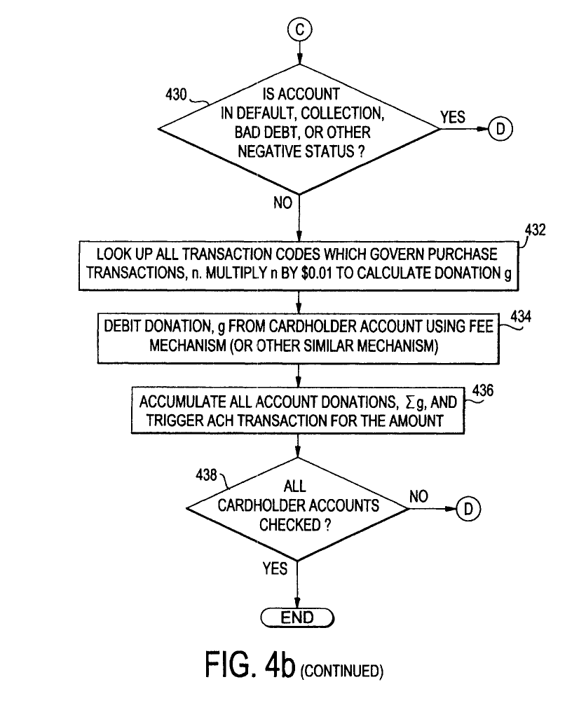

In step 308, the card-issuing financial institution 210 updates a database record 510 in a database 512 (as best seen in FIG. 5) associated with the cardholder's 202 individual cardholder account to show the opt in status. The computer-readable database record 510 is stored in the database 512 or in memory associated with a card-issuing financial institution server 604. Alternatively, the computer-readable database record 510 could be stored in a database or memory associated with the charitable organization's 102 server (not shown). The card-issuing financial institution server 604 would then interrogate the charitable organization 102 servers to read the database record and determine which cardholder 202 has opted in. Any other technique for identifying cardholders 202 and/or cardholder accounts that have opted in to make donations is contemplated to be within the scope of the present invention.

In step 310, the cardholder 202 uses the card 206 issued by the card-issuing financial institution 210 at a merchant 204 to pay for goods and/or services provided by merchant, in the manner described previously. The merchant 204 may use a point-of-sale terminal to electronically record information about the transaction, such as product information, sales price, etc. The merchant 204 may use a card reader (not shown) to download information from the card 206 into an input device (not shown) for transmission to the clearing house 208 or acquirer as noted above.

In step 312, the card-issuing financial institution 210 updates the database record 510 for the cardholder's 202 individual cardholder account to show the transaction at the merchant 204 location.

In one embodiment of the invention, at the end of a pre-determined time period, the system confirms at least ten dollars are available in funds. Thus, in the case of a credit card, if the credit limit on the account minus the total balance on an account is less than $10, the system will not process a donation amount. Similarly, in the case of a debit card, if the current balance on an account is less than $10, the system will not process a donation. Other criteria are also checked at this point, such as whether the account is in default, past due, overlimit, or any other status other than “current.”

In step 314, at end of a pre-determined time period, and after the above checks are made, the number of individual transactions associated with the cardholder's 202 individual cardholder account are summed, and a donation amount, g, is computed. The number of transactions is determined by looking up all transaction codes which govern purchase transactions. For example, the number of transactions, n, may or may not exclude transactions that do not involve the purchase of goods and/or services, such as intra-account transfers, cash withdrawals, balance inquiries, and others that may be specifically designated.

The donation amount g may be computed, for example, by the card-issuing financial institution 210 by aggregating the number of transactions, n, involving the cardholder's 202 card 206 made during the pre-determined time period, T,and multiplying that number by a pre-determined multiplier, p1 (i.e., n p1).

For example, n may be 30 transactions, T may be 30 days, and p1 may be $0.01, thus the donation amount, g, added to the cardholder's 202 statement 214 would be $0.30 at the end of the 30 day period.

g=(30 transactions×0.01$/transaction)=$0.30

The time period which is used to determine the number of transactions may be different than the standard billing cycle, T, for the cardholder's 202 card 206. For example, the number of transactions could be based on 2T, or 45 days, or any other time period, or any other triggering event, like the first Monday of each month. Moreover, the number of transactions may be based on the number of transactions for a previous month, or some other earlier time period. For example, a cardholder 202 may elect to have his or her donation amount computed on the basis of the transactions for a previous month, the most current month, year to date, every other month, etc. The historical records for the number of transactions associated with a particular cardholder's 202 individual cardholder account may be obtained from the third party clearing house 208 or some other source.

The donation amount, g, may also be computed, for example, by the card-issuing financial institution 210 by multiplying the total value, m, of all transactions processed for a particular cardholder 202 during the time period, T, and multiplying that number by a pre-determined multiplier, p2 (i.e., m×p2).

For example, m may be $30, Tmay be 30 days, and p2 may be 0.01, thus the donation amount, g, added to the cardholder's 202 statement 214 would be $0.30 at the end of the 30 day period.

g=($30×0.01$/$)=$0.30

In each of those examples, the multipliers p1 and p2 could be variable, or indexed to the level of usage or to specific types of merchants 204, such as authorized merchants. Thus, the value of p1, for example, might be higher for third parties, like restaurants that participate in a charitable program operated by the card-issuing financial institution, or for specific third parties that are known to have strong ties to a particular community or region.

Also, the fixed or variable amounts may also be determined on a per-commercial transaction basis rather than waiting until the end of the credit card cycle, (i.e., Σ[(1/n)×p1]).

In step 316, the information required to process a transaction to debit the calculated donation amount, g, from the cardholder's 202 individual cardholder account is generated. The donation amount is debited using a fee mechanism (or other similar mechanism).

In step 318, the donation amount and any corresponding transaction is recorded and identified in a temporary log file on the card-issuing financial institution server 604.

In step 320, the program checks to see if there are any more cardholder accounts to process. If there are no more accounts, then in step 322, the card-issuing financial institution 210 adds the sum of the individual donation amounts in the log file associated with each participating cardholder 202, and in step 324, the card-issuing financial institution 210 calculates the number of line items in the log (i.e., number of donations).

In step 326, an automatic clearing house (ACH) transaction is originated by the card-issuing financial institution using the information in the temporary log file and using the routing number (RTN) and specific account number for the charitable organization's 102 charitable account set up to receive the aggregated donation amounts from the card-issuing financial institution.

In step 328, the card-issuing financial institution outputs a report via email or other means, to report to the charitable organization 102 the total aggregated donation calculated for the time period, T, the RTN, the number of individual donations, plus any other information it wishes to communicate. The process then repeats from the beginning, or terminates.

The debited donation amount, g, is indicated as a transaction on the cardholder's 202 regular statement 214 that is delivered to the cardholder 202 via regular or electronic mail, or otherwise made available to the cardholder 202 by the card-issuing financial institution 210.

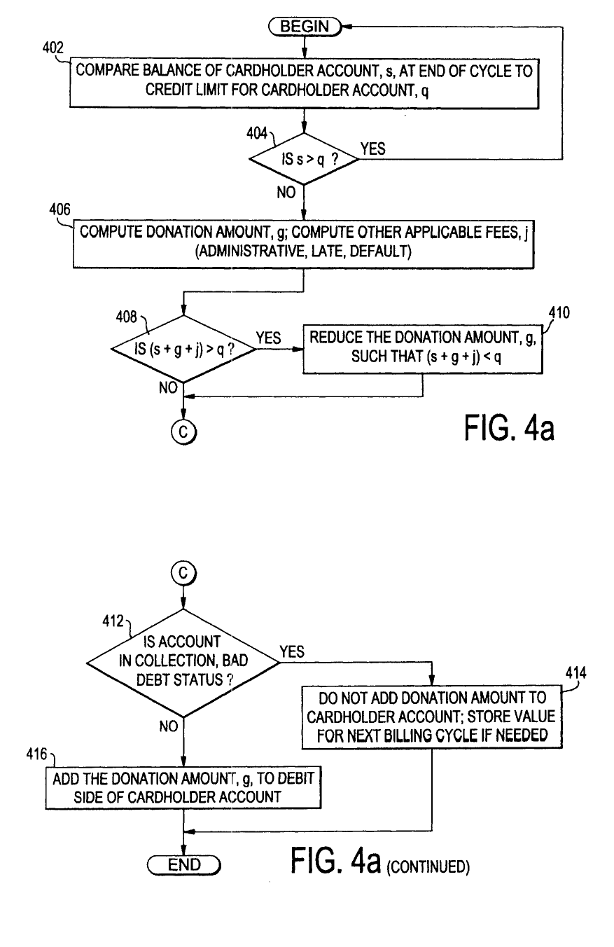

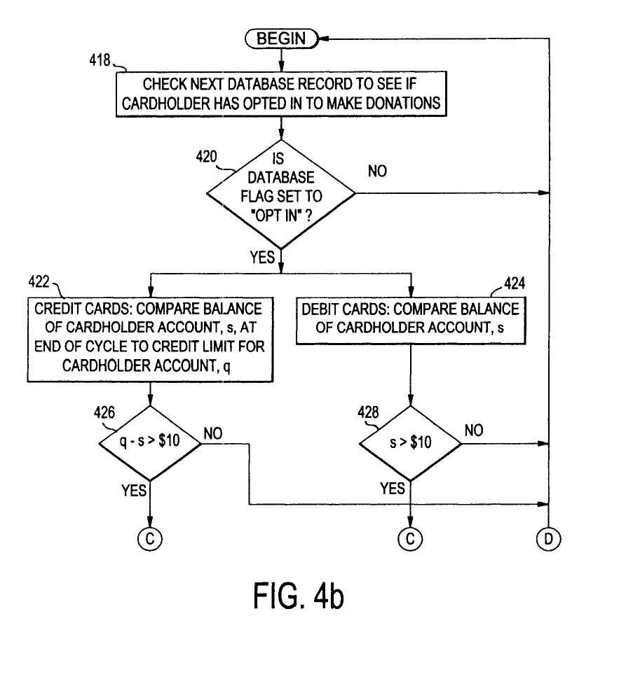

Turning now to FIGS. 4a and 4b, shown therein are process flow diagram detailing the logic routine for determining whether a cardholder's 202 individual account can be debited an amount equal to the donation amount, g. Certain conditions may be established that prevent the calculated donation amount, g, from being debited, as shown in the figures and described below.

In step 402, the current balance, s, of the cardholder's 202 individual cardholder account is obtained at time, t, which may correspond to the date the standard billing cycle ends for the individual cardholder account, and which may further correspond to the date when the donation amount, g, is calculated. The credit limit, q, is also obtained. In step 404, the current balance, s, is compared to the credit limit, q. If the current balance exceeds the credit limit, the system does not compute a donation amount, g. Instead, the system waits for the next time period to end, i.e., at t+T, and check the account status again.

If the current balance does not exceed the credit limit, the system computes the donation amount, g, in the manner previously described. It also computes other fees,j, such as administration fees, late fees, default fees, etc.

In step 408, the system adds the donation amount and other fees to the current balance (i.e., s+g+j) and compares the total to the credit limit, q. If the sum is greater than the credit limit, the system reduces the donation amount to a new value, g1, such that (s+g1+j)<q. The difference between the computed donation amount, g, and the reduced donation amount, g1, may be stored or recorded and added to the next donation amount that is calculated at time t+T. Thus, if whenever the computed donation amount, g, will cause the cardholder's 202 individual cardholder account balance, s, to exceed a pre-determined maximum credit limit, q, or some other pre-determined maximum value, the donation amount will be reduced to a new, adjusted level, which could be zero, that does not cause the account balance to exceed the pre-determined maximum limit set by the card-issuing financial institution 210. And, in the same manner, if the calculations described above cause the imposition of an administrative fee, late fee, default penalty fee, and/or an increase in the stated interest rate associated with the cardholder's 202 individual cardholder account, the donation amount will be reduced to a new, adjusted level, which could be zero, that does not cause any of those conditions.

In step 412, the calculations described above may not be performed if the individual cardholder account is flagged for late payment, default, collection, or bad debt status, or if it has been submitted to a third party for collection purposes. If any of those conditions or situations are present, then in step 414, the calculated donation amount, g, will not be added to the account balance, but it could be stored or recorded and added to the next donation amount that is calculated at time t+T. Otherwise, if none of the conditions or situations are present, then in step 416, the donation amount, g, is debited from the cardholder's 202 individual cardholder account.

In FIG. 4b, in step 418, the database records of a card-issuing financial institution 210 are each checked to see if the cardholder 202 has opted in to make donations to one or more charitable organizations 102. If, in step 420, the database record includes a field that indicates that the cardholder 202 has opted in, and if the card 206 is a credit card, then in step 422 the balance of the cardholder account, s, at end of the time period, T, is compared to the credit limit, q, for the cardholder account. In step 426, the difference is checked to make sure that there is at least $10 left in the account. Similarly, if, in step 420, the database record includes a field that indicates that the cardholder 202 has opted in, and if the card 206 is a debit card, then in step 424, the balance, s, of the account is checked to make sure there is at least $10 left in the account. The $10 threshold may be set to different amounts for different cardholder accounts, or may be changed from one cycle to the next. If the checks made in steps 426 and 428 show that there is insufficient funds available, the routine loops back to the beginning to check the next cardholder account.

In step 430, the individual cardholder account is checked to see if it is flagged for late payment, default, collection, or bad debt status, or if it has been submitted to a third party for collection purposes. If none of those conditions or situations are present, then the above calculations for the donation amount, g, are performed. That is, in step 432, the routine looks up all transaction codes which govern purchase transactions, n, which is then multiplied by $0.01 to calculate the donation amount, g. In step 434, the donation amount, g, is then debited from the cardholder account using a fee mechanism (or other similar mechanism). In step 436, the accumulated account donations, Σg, is computed, and an ACH transaction is triggered for the amount. In step 438, the database is checked to see if there are any additional cardholder accounts to process.

Turning now to FIG. 5, shown therein is a schematic diagram of the system according to the present invention. The card-issuing financial institutions 210 participating in the donation program may implement the system and method in one of several ways, including providing an electronic input form displayed in a graphical user interface on a client computer 502, or providing a paper application 504 that allows cardholder 202 to opt-in or opt-out of the donation program described herein. Other methods include email, using the phone to contact a participating card-issuing financial institution 210, or other suitable means. In the case of the electronic form transmitted from the client computer 502, the electronic form is transmitted over a communications network 506 and received by the card-issuing financial institution server 508.

The communications network 506 may be several networks in data communication with each other. They are used to link various servers, databases, and data records, to facilitate the computer-implemented transfer of signal information and, ultimately, the electronic transfer of money donations.

Because the card-issuing financial institutions already generate statements 214 at the end of each cardholder's 202 billing cycle, they are able to easily add another transaction to the statements 214 of each cardholder 202 that has opted in to the program to shows a donation amount equal to the amounts calculated in the manner described above. This may be done, for example, by setting a code or parameter in the database record 510 associated with each individual cardholder account for which a cardholder 202 has opted in to the donation program; the code or parameter is preferably computer readable as described above. Once the code or parameter is recognized, it triggers the calculations described above.

The present system contemplates a plurality of card-issuing financial institution servers 508, a plurality of individual cardholder accounts stored as database records 510, a plurality of credit or debit card financial instruments, at least one charitable organization server (not shown), and donation recipient accounts associated with the charitable organizations 102.

The database 512 may be central, remote, and/or distributed; and the plurality of individual cardholder accounts, and the donation recipient accounts, may be stored on one or more of the databases 512 in order to store records containing information related to the system. The system may also involve at least one charitable organization server in data communication with the other devices recited above.

The card-issuing financial institution servers are associated with card-issuing financial institutions 210, such as banks, savings and loans, credit unions, securities brokers, and the like, all of which are regulated and authorized to issue credit and debit card instruments.

In one embodiment of the invention, each of the cards 206 could be linked to one or more of the plurality of individual cardholder accounts, such that when the card 206 is used in connection with a commercial transaction, such as purchase of consumer goods and/or services, the individual cardholder accounts are updated to reflect that transaction. This is preferably accomplished by transferring the funds electronically (i.e., EFT), which requires a data communications link between the point-of-sale terminal where the commercial transaction is entered, an acquirer server, an the card-issuing financial institution servers where the cardholder's 202 individual cardholder account is maintained. The transaction may need to be authorized by an authorization entity.

The cards 206 may be an affiliation or relationship partner 212 card that designates on its face the name of the entity associated with the charitable organization server, such as United Way of America®.

Preferably, the card-issuing financial institution settles payments to the charitable organization server by use of common card settlement processes and protocols, such as the ISO 8583 EFT standard.

The card-issuing financial institution servers 508 could also be linked to one or more charitable organization servers, in order to transmit signals to those charitable organization servers regarding information about one or more donations. Those signals could involve EFT payments to the charitable organization.

Alternatively, instead of electronically transmitting payment to the charitable organization 102, the card-issuing financial institution 210 may elect to send a paper check instead. Any method of transmitting, delivering, or providing the funds to the charitable organization 102 is contemplated.

The client computers 502, card-issuing financial service servers 508, and charitable organization servers include processor, memory, communications interfaces, and software, among other features.

Monetary donations are cleared immediately after the calculations described above are completed. That is, the money is not temporarily deposited in a separate account associated with the cardholder's 202 individual cardholder account, or aggregated with other cardholder's donations, and then transferred to the charitable organization, although that method may be used. Thus, a separate account, such as a sub-account linked to the cardholder's 202 individual cardholder account at the card-issuing financial institution that issued the card, is not required, which greatly simplifies the process and accounting.

As mentioned previously, the charitable organizations 102 that are designated to receive the donation amounts, g, may establish one or more accounts receivable associated with each cardholder 202 that has designated that charitable organization 102 to receive donations from the card-issuing financial institutions 210. Separate accounts receivable for each cardholder 202 is not required; however, all donations from all sources made in accordance with the present invention could be aggregated in a single accounts receivable that is not linked to any particular individual or financial institution or card issuer. Monetary donations received via electronic fund transfers into the accounts receivable are then distributed by the charitable organizations 102 based on pre-determined rules or criteria, some of which may be determined by the cardholder 202. Thus, the charitable organization 102 is able to coordinate the collection of monetary donations in a manner that has very little impact on cardholders 202 while at the same time generating a steady revenue stream for needy beneficiaries or charitable programs run by the charitable organizations 102.

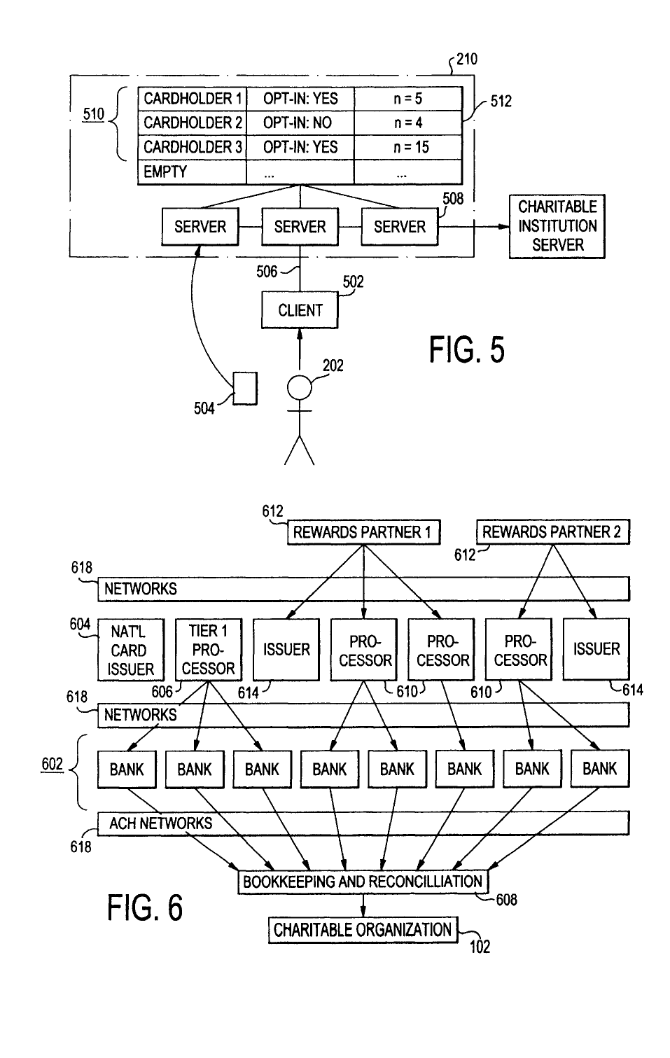

Turning now to FIG. 6, shown therein is a schematic drawing showing the interrelationship between coordination entities according to the present invention. The card-issuing financial institutions 210 are individual banks 602, which issue their own cards 206. Each of the banks 602 is in data communication with a third party bookkeeping and reconciliation entity 608 over one or more networks 618. The arrows from the banks 602 to the third party bookkeeping and reconciliation entity 608 and then to the charitable organization 102 indicate the flow of funds from the banks to the charitable organization 102 in addition to the electronic transfer of other related information and data.

A national card issuer 604, also issues cards 206, but is not necessarily tied to any particular bank 602. Some of the banks 602 may use a tier 1 processor 606, which works directly with a third party bookkeeping and reconciliation entity 608 to process donations to the charitable organizations 102. Some of the banks 606 work directly with their own intermediate processors 610 and rewards partners 612 and through the third party bookkeeping and reconciliation entity 608 to process donations. Other card issuers 614 that are not necessarily related to any individual bank 602 may also work with the rewards partners 612 and the third party bookkeeping and reconciliation entity 608 to process donations. The arrows between the national card issuer 604, tier 1 processor 606, intermediate processors 610, other card issuers 614, the banks 602, and the rewards partners 612 indicate automated processing in addition to the electronic transfer of related information and data. Each of the block in FIG. 6 represent at least one server and any necessary databases for storing relevant information.

Unlike traditional affinity cards, cardholders 202 that opt in to the donation program of the present invention do not have to open a new account or sub-account, which can affect or be effected by their individual credit history.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

I claim:

1. A computer-implemented method for coordinating monetary donations to one or more designated beneficiaries comprising the steps of:
providing on a server associated with a charitable organization an account designated for receiving a donation amount by way of an electronic fund transfer from a financial institution server;
at the financial institution server,
a) providing a cardholder account for debiting the donation amount;
b) linking one or more cards to the cardholder account;
c) determining whether to compute the donation amount;
d) computing the donation amount based on a pre-determined formula involving multiplying a first variable representing an aggregate number of eligible transactions made using the card during a fixed period of time and a second variable representing a fixed multiplier;
e) debiting the donation amount from the cardholder account; and
f) outputting a statement associated with the cardholder account showing the donation amount; and
allocating the donation amount to the one or more designated beneficiaries at a pre-determined second time period or concurrently with the first time period.

2. The method according to claim 1, further comprising the step of receiving an opt-in message from a cardholder.

3. The method according to claim 1, further comprising the step of storing the computed donation amount in a memory.

4. The method according to claim 1, further comprising the step of generating an instruction and information to debit the donation amount from the cardholder account.

5. The method according to claim 1, further comprising the step of completing an electronically fund transfer of the donation amount to the designated account.

6. The method according to claim 1, further comprising the step of outputting a message to the charitable organization that an electronic fund transfer has been completed.

7. The method according to claim 1, further comprising comparing a first set of criteria to determine whether to debit the cardholder account an amount equal to the computed donation amount

8. The method according to claim 7, wherein the first set of criteria are the current balance and the credit limit of the cardholder account.

9. The method according to claim 7, wherein the first set of criteria comprises a pre-determined minimum amount of money.

10. The method according to claim 1, wherein the step of debiting comprises:
performing a fee-based transaction for the cardholder account; and
storing the donation amount in a temporary log file.

11. The method according to claim 10, wherein the temporary log file is used to create an ACH file.

12. A computer-implemented method for debiting monetary donations comprising the steps of:
providing a cardholder account for debiting a donation amount;
linking one or more cards to the cardholder account;
computing the donation amount based on a pre-determined formula involving multiplying a first variable representing an aggregate number of eligible transactions made using the card during a fixed period of time and a second variable representing a fixed value of money;
comparing the computed donation amount against a first set of criteria to determine whether to debit the cardholder account an amount equal to the computed donation amount;
debiting the donation amount if the first set of criteria are satisfied;
outputting a statement associated with the cardholder account showing the donation amount; and
electronically transferring the donation amount to at least one charitable organization.

13. The method according to claim 12, wherein the one or more cards is a credit or debit card.

14. The method according to claim 12, wherein the cardholder account is a credit card debt account or a pre-loaded debit account.

15. The method according to claim 12, wherein the step of electronically transferring the donation amount to at least one charitable organization comprises transferring the donation amount to a third party bookkeeper.

16. A system for coordinating monetary donations to one or more designated beneficiaries comprising:
an electronic fund receiving device associated with a charitable organization operable to receiving and storing a first data signal representing monetary donations;
electronic fund transferring means in data communication with the electronic fund receiving device for receiving and storing a second data signal representing consumer transactions associated with a card;
a storage medium containing computer code instructions for aggregating card usage over a pre-determined time period and for outputting the first data signal;
means for outputting a transaction record upon receipt at the first server of the first data signal; and
means for distributing the monetary donations.

17. The system according to claim 16, wherein the electronic fund receiving device is a server in data communication with the electronic fund transferring device.

18. The system according to claim 16, wherein the instructions comprise instructions for performing the steps:
a) providing a cardholder account for debiting a donation amount;
b) linking one or more cards to the cardholder account;
c) determining whether to compute the donation amount;
d) computing the donation amount based on a pre-determined formula involving multiplying a first variable representing an aggregate number of eligible transactions made using the card during a fixed period of time and a second variable representing a fixed multiplier; and
e) debiting the donation amount from the cardholder account.

19. The system according to claim 16, wherein the means for distributing the monetary donations comprises identifying beneficiaries and electronically transferring at least part of the monetary donations to the identified beneficiaries.

20. The system according to claim 16, wherein the card is a bank-issued credit card.
